(19) United States
(12) Patent Application Publication
(10) Pub. No.: US 2015/0149469 A1
(43) Pub. Date: May 28, 2015

(54) METHODS AND APPARATUS FOR ASSOCIATING INTEREST TAGS WITH MEDIA ITEMS BASED ON SOCIAL DIFFUSIONS AMONG USERS

(71) Applicants: Tong Xu, Beijing (CN); Hengshu Zhu, Beijing (CN); Huanhuan Cao, Beijing (CN); Dong Liu, Beijing (CN); Jilei Tian, Beijing (CN)

(72) Inventors: Tong Xu, Beijing (CN); Hengshu Zhu, Beijing (CN); Huanhuan Cao, Beijing (CN); Dong Liu, Beijing (CN); Jilei Tian, Beijing (CN)

(73) Assignee: NOKIA CORPORATION, Espoo (FI)

(21) Appl. No.: 14/400,943

(22) PCT Filed: Jun. 14, 2012
(86) PCT No.: PCT/CN2012/076932

§ 371 Date: Nov. 13, 2014

(51) Int. Cl. G06F 17/30; H04L 29/06

(52) U.S. Cl. CPC G06F 17/30876; H04L 65/403
USPC 707/740

(57) ABSTRACT

An approach is provided for associating interest tags with media items based on social diffusions among users. The media tagging platform processes and/or facilitates a processing of one or more user profiles to determine one or more interest tags relating to one or more users, captured at one or more user devices to determine one or more frequencies of the one or more signals. Next, the media tagging platform determines one or more social diffusions of the one or more media items among the one or more users. Then, the media tagging platform causes, at least in part, an association of the one or more media items with the one or more interest tags based, at least in part, on the one or more social diffusions.

### BACKGROUND

Service providers and device manufacturers (e.g., wireless, cellular, etc.) are continually challenged to deliver value and convenience to consumers by, for example, providing compelling network services. One area of interest has been the development of services that providing automatic media tagging. For example, as the number of services that enable grassroot users to upload personal multimedia content, such as photographs, music, and videos, to social networks continues to grow, categorizing the personal multimedia content becomes a critical task. Typically, automatic categorizations of media items are performed by processing textual descriptions and tagging information embedded in the media items to determine media tags for the media items. However, personal multimedia content generally lack embedded textual descriptions and tagging information, making typical automatic media tagging an unworkable approach.

### SOME EXAMPLE EMBODIMENTS

Therefore, there is a need for an approach for associating interest tags with media items based on social diffusions among users.

According to one embodiment, a method comprises processing and/or facilitating a processing of one or more user profiles to determine one or more interest tags relating to one or more users. The method also comprises determining one or more social diffusions of the one or more media items among the one or more users. The method further comprises causing, at least in part, an association of the one or more media items with the one or more interest tags based, at least in part, on the one or more social diffusions.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more user profiles to determine one or more interest tags relating to one or more users. The apparatus is also caused to determine one or more social diffusions of the one or more media items among the one or more users. The apparatus is further caused to cause, at least in part, an association of the one or more media items with the one or more interest tags based, at least in part, on the one or more social diffusions.

According to another embodiment, a computer-readable storage medium carries one or more sequences of one or more instructions which, when executed by one or more processors, cause, at least in part, an apparatus to process and/or facilitate a processing of one or more user profiles to determine one or more interest tags relating to one or more users. The apparatus is also caused to determine one or more social diffusions of the one or more media items among the one or more users. The apparatus is further caused to cause, at least in part, an association of the one or more media items with the one or more interest tags based, at least in part, on the one or more social diffusions.

According to another embodiment, an apparatus comprises means for processing and/or facilitating a processing of one or more user profiles to determine one or more interest tags relating to one or more users. The apparatus also comprises means for determining one or more social diffusions of the one or more media items among the one or more users. The apparatus further comprises means for causing, at least in part, an association of the one or more media items with the one or more interest tags based, at least in part, on the one or more social diffusions.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 36-38.

Still other aspects, features, and advantages of the invention are readily apparent from the following detailed description; simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of associating interest tags with media items based on social diffusions among users, according to one embodiment;

FIG. 2 is a diagram of the components of a media tagging platform, according to one embodiment;

FIG. 3 is a flowchart of a process for associating interest tags with media items based on social diffusions among users, according to one embodiment;

FIG. 4 is a flowchart of a process for tagging media items based on a potential tag set, according to one embodiment;

FIG. 5 is a flowchart of a process for initiating social diffusion of media items among users, according to one embodiment;

FIG. 6 is a flowchart of a process for media tagging based on social diffusions among users, according to one embodiment;

FIG. 7 is a diagram of a framework for associating interest tags with media items based on social diffusions among users, according to one embodiment;

FIG. 8 is a diagram of a scenario where interest tags are associated with media items based on social diffusions among users, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for associating interest tags with media items based on social diffusions among users are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

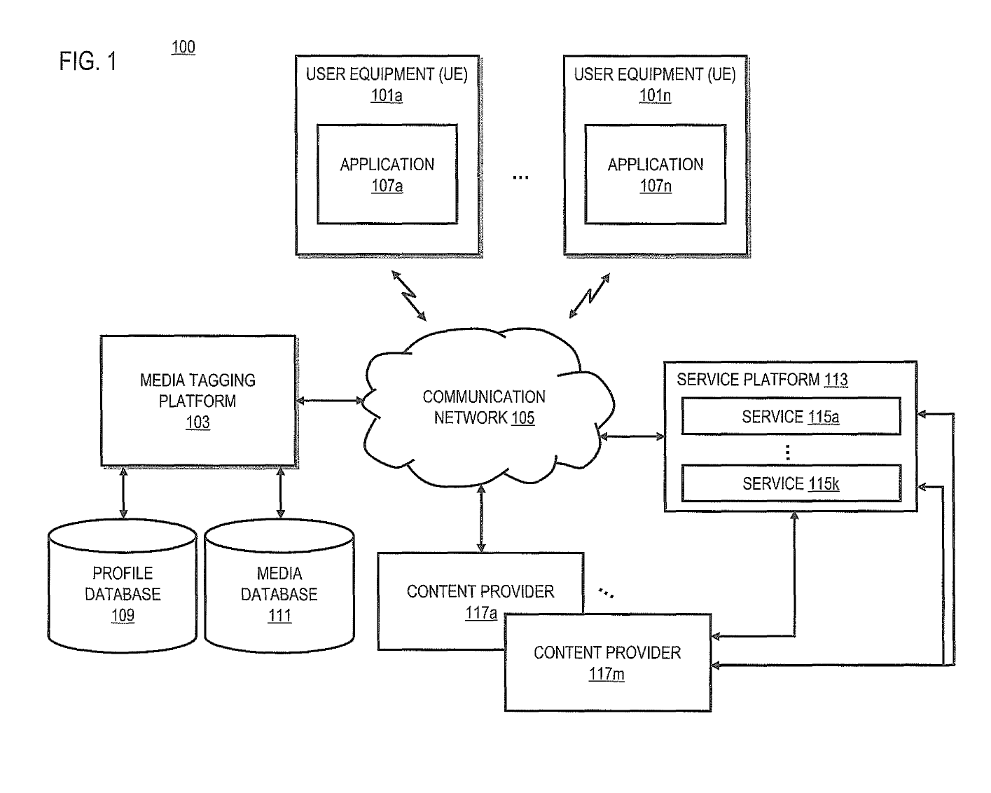

FIG. 1 is a diagram of a system capable of associating interest tags with media items based on social diffusions among users, according to one embodiment. As mentioned, categorization of media items (e.g., music, videos, images, media applications, etc.) becomes increasingly necessary as the number of services that enable grassroot users to upload personal multimedia content, such as photographs, music, and videos, to social networks continues to grow. However, because personal multimedia content generally lack embedded textual descriptions and tagging information, the typical automated approach that relies on processing of embedded textual descriptions and tagging information to determine media tags for media items may be ineffective.

To address this problem, a system 100 of FIG. 1 introduces the capability to tag media items based on social diffusions among users. Specifically, the system 100 may process user profiles to determine interest tags relating to one or more users. The user profiles may, for instance, include user preferences, relationships among the users, sharing histories, etc. Then, the system 100 may determine social diffusions of the media items among the users, and cause an association of the media items with the interest tags based on the social diffusions. By way of example, the association may be performed by adding or modifying metadata of the media items to specify that the media items are associated with the interest tags. In one embodiment, metadata of a media item may include a particular interest tag that has been associated with the media item, for instance, to indicate that the media item has been “tagged” with the particular interest tag. In another embodiment, metadata of a media item may indicate that the media item has been “tagged” with a particular interest tag by specifying a link, a code, etc., corresponding to a tag set that contains interest tags (e.g., including the particular interest tag) for the media item.

In some embodiments, the social diffusions may include a sharing of at least one of the media items by at least one of the users to at least another one of the users. Since common interests tags (or common interests) between pairwise sharers may reflect the character of a shared media item, those common interest tags may be relevant tags for the shared media item. For example, certain common interest tags may represent the attribute of a shared media item with a higher probability where those common interest tags reappear frequently among pairwise sharers for the shared media item. As such, the association of the media items with the interest tags may be based on the sharing. Moreover, in certain embodiments, the interest tags may be determined based, at least in part, on a predetermined set of common categories, clarified tags, etc. For example, the predetermined set may include tags that are chosen and predefined. In this way, since the interest tags are determined from the predetermined set, ambiguous and redundant tags for the media items may be avoided. Furthermore, because the social diffusion approach to media tagging does not need to rely on textual descriptions and tagging information embedded in the media items, the issue of insufficient embedded textual descriptions and tagging information in personal media content (or other media items) may be overcome. It is noted, however, that if such textual descriptions and tagging information exists for a media item, those textual descriptions and tagging information may also be utilized in automated media tagging along with the social diffusion approach.

As shown in FIG. 1, the system 100 comprises a user equipment (UE) 101 (or multiple UEs 101a-101n) having connectivity to a media tagging platform 103 via a communication network 105. The UE 101 may include or have access to an application 107 (e.g., applications 107a-107n) to enable the UE 101 to interact with, for instance, the media tagging platform 103, which may: (1) process user profiles to determine interest tags relating to one or more users; (2) determine social diffusions of the media items among the users; (3) cause an association of the media items with the interest tags based on the social diffusions; (4) cause an addition and/or a modification to a potential tag set associated with a media item based on a sharing of the media item by one user to another user; (5) cause tagging of the media item with an interest tag associated with a user based on the sharing and predetermined criteria; (6) cause a categorization of the users into communities based on the interest tags and/or the user profiles; (7) determine seed users from the communities based on a determination to cover the interest tags associated with the communities; (8) cause a generation of recommendations of the media items for the seed users for initiating social diffusion; or (9) perform other functions.

In various embodiments, the media tagging platform 103 may include or have access to a profile database 109 to access or store user profiles for determining one or more interest tags relating to users associated with the user profiles. As indicated, the user profiles may include user preferences, relationships among the users, and/or sharing histories among other profile information. The media tagging platform 103 may also include or have access to a media database 111 to access or store media items, diffusion logs associated with the media items (e.g., logs indicating sharing routes of the media items, sharing users who shared the media items, users who received the media items from sharing users, etc.), or other media-related data. Data stored in the profile database 109 and the media database 111 may, for instance, be provided by the UEs 101, a service platform 113, one or more services 115 (or services 115a-115k), one or more content providers 117 (or content providers 117a-117m), and/or other services available over the communication network 105. For example, users (e.g., via UEs 101) and services 115 may provide media items to the media database 111 (e.g., users may provide personal media content, services 115 may provide commercial media content, etc.). It is noted that the media tagging platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the media tagging platform 103 may cause, at least in part, an addition, a modification, or a combination thereof to a potential tag set associated with the at least one media item based, at least in part, on the sharing (of at least one of the media items by at least one of the one or more users to at least another one of the one or more users), and the association of the one or more media items with the one or more interest tags may further be based, at least in part, on the addition, the modification, or a combination thereof. For example, under the assumption that sharing indicates preference/interest, the common interest tags of the sharing user (e.g., the at least one user) and the receiving user (e.g., the at least another user) may be regarded as potential tags of the shared media item with a specific weight. As such, the sharing of the media item may, for instance, cause a common interest tag of the two users to be added to the potential tag set for the media item and/or cause a modification of the tags in the potential tag set based on the common interest tag of the two users. In various embodiments, the weight of the potential tags may be calculated in advance, via analysis of the pairwise relationship between the two users (e.g., sharing histories between the two users, mutuality of shares, etc.). In addition, as social diffusion continues, more information may be collected and higher precision may be achieved. When a predefined threshold is reached (e.g., when the tags of the potential tag set converges (and fluctuation is below the threshold)), those tags may then be associated with the media item (e.g., by indicating those tags in metadata of the media item).

In another embodiment, the media tagging platform 103 may cause, at least in part, a tagging of the at least one media item with at least one of the one or more interest tags associated with the at least one user, the at least another user, or a combination thereof based, at least in part, on the sharing and one or more predetermined criteria. In certain embodiments, the one or more predetermined criteria may, for instance, include a relationship criterion, a time criterion, a frequency criterion, or a combination thereof. As mentioned, common interest tags between users involved in sharing of a media item may be regarded as potential tags of the media item. These potential tags may, for instance, be assigned a specific weight based on the relationship between the users (e.g., sharing histories between the two users, mutuality of shares, etc.), the number of times the media item has been shared, the frequency that the potential tags appear as common interest tags of users in sharing transactions, etc. Thus, the predetermined criteria may be utilized to determine the “degree of reliability” of those derived potential tags.

Specifically, since the motivation among users to share a media item may vary, further verification involving the predetermined criteria may be needed. By way of example, parents may share some media items with their children because the parents may believe that those media items are “beneficial” for their children, as opposed to sharing because they believe that the media items are of interest to their children. As such, those media items may not reflect the common interests of the parents and their children. Nonetheless, it may be determined that the relationship between the parents and their children involve frequent one-way transfers (e.g., from parent to children), rather than frequent mutual interactions, which may indicate that the common interest tags of the parents and their children as potential tags for the shared media item should be given little weight. Consequently, those particular potential tags may not be utilized as actual tags for the shared media item. On the other hand, potential tags associated with common interest tags of pairwise sharers having substantial similarities (e.g., many common interests, same communities, etc.) and frequent mutual interactions/transfers may be assigned greater weight, resulting in a higher probability that the potential tags will become the media tags for the shared media item (e.g., by indicating those tags in metadata of the shared media item).

Thus, the assigned weights of the potential tags may reflect the degree of reliability. In some embodiments, factors that may be considered in calculating the degree of reliability (or weight) of a potential tag may include user profile similarities (e.g., many common interests, same communities, etc.), bidirectionality of relationships (e.g., bidirectional friends relationships, mutual interactions/transfers, etc.), and transfer frequencies and gaps between transfers (e.g., based on transfer logs), along with external factors, such as fashion trends, breaking news, etc. These factors may, for instance, be treated with statistical feature analysis to derive weights (e.g., statistical significance), and then combined (e.g., multiplied) with different weights. Smooth factors (e.g., for avoiding influence of “0” multipliers) may also be introduced if needed. As such, the result represents the probability that common interest tags are reliable as a potential tag of the media item. In certain embodiments, such results may be calculated offline, and stored as part of a matrix, for instance, to make checking and utilization online more efficient and convenient.

In another embodiment, the media tagging platform 103 may cause, at least in part, a categorization of the one or more users into one or more communities based, at least in part, on the one or more interest tags, the one or more user profiles, or a combination thereof. By way of example, users may be divided into different social latent communities based on their corresponding interest tags, their user relationships, and their sharing histories (e.g., derived from their user profiles). In one use case, certain users may be placed together in the same “hip-hop” social community if, for instance, those users are friends, they have previously shared media items amongst each other, and they are interested in hip-hop music. It is noted that such categorization may be implemented via a number of techniques, including, for example, clustering methods based on graph theory.

In another embodiment, the media tagging platform 103 may determine one or more seed users from the one or more communities based on a determination to cover the one or more interest tags associated with the one or more communities, and the one or more seed users may include, at least in part, the at least one user, at least one provider of the at least one media item, or a combination thereof. In a further embodiment, these training sample users (e.g., the seed users) may be segmented into a few social groups with multiple labels (e.g., indicating different interest tags), for example, since training sample sizes may be better controlled in limited amounts. In addition, in various embodiments, social diffusion may be focused around uploaders (e.g., the at least one provider of the at least one media item). However, because uploaders may sometimes only make up a small group, some potential tags may not be covered by the interest tags relating to that group. Thus, in certain embodiments, random users having different interest tags may be selected as seed users to cover all, or most, of the possible potential tags (e.g., from the predetermined set of common categories, clarified tags, etc.). For example, users may be randomly selected from each of the social latent communities to be seed users to form a selected seed group having all of the interest tags associated with the social latent communities.

In another embodiment, the media tagging platform 103 may cause, at least in part, a generation of one or more recommendations of the one or more media items for the one or more seed users, and the one or more social diffusions may be based, at least in part, on the one or more recommendations. In one scenario, for instance, privacy policy settings may prevent some media items from circulating outside a private group/community, while allowing the majority of media items (e.g., having default permissions) to be publicly shared. As indicated, in order to achieve a more comprehensive tagging result, seed users may be randomly chosen from the different communities. Because data sparsity may influence the quality of the community extraction process (e.g., the categorization of the users into common interest-based communities), at least a limited reduplication may be needed. In addition, approaches such as greedy algorithms may be utilized to overcome the covering issue in the selection of the seed users. Once the seed users are selected, new or untagged media items may be recommended to the seed users (e.g., which may include the uploaders of the new or untagged media items). If, for instance, a seed user views and shares a recommended media item, such actions may indicate his/her interest in the media item and, thus, interest tags relating to that seed user (e.g., common interest tags of pairwise sharers) may be assigned as potential tags with particular weights for the media item. Further views and shares by users receiving the media item may then cause modification of the potential tags' assigned weights, addition of other potential tags, etc., for example, until a reliability threshold has been satisfied, resulting in the potential tags becoming actual tags for the media item.

In a further scenario, if there are recommended media items that have not been assigned a reliable media tag (e.g., the media items do not have any potential tags that have met the reliability threshold), those recommended media items may be recommended to other seed users who have not yet received the recommended media items (e.g., those particular media items have not yet been recommended to them) to initial another round of sharing by seed users. Additionally, or alternatively, a new set of seed users may be selected from the different communities, and the untagged media items that have already been recommended to the first set of seed users will then be recommended to the new set of seed users to initial another round of sharing by seed users.

In another embodiment, media items having a sufficient history of transfers/shares (e.g., stored in transfer/share logs) may be utilized as training samples to associate interest tags with media items. By way of example, since similar media items will typically attract users with similar interests (e.g., especially for local grassroot media items), similar media items may have similar transfer routes/tracks (e.g., similar media items will likely be shared by users in a first user set to users in a second user set). As such, associated rule analysis or collaborative filtering techniques may be utilized to generate mapping relationships with specific scores between transfer routes/tracks and certain tags (e.g., particular interest tags). Those mapping relationships may then be used as “rules” to determine tags for new or untagged media items. In one use case, for instance, the route between user A to user B may be a transfer route/track that corresponds to interest tag X with a weight of 30%, an interest tag Y with a weight of 50%, an interest tag Z with a weight of 70%. Thus, if an untagged media item is shared between user A to user B, the potential tag set of the untagged media item may be modified based on the interest tags X, Y, and Z with their varying weights (e.g., adding the interest tags X, Y, and Z to the potential tag set with their respective weights if those interest tags does not currently exist in the potential tag set).

By way of example, the UE 101, the media tagging platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

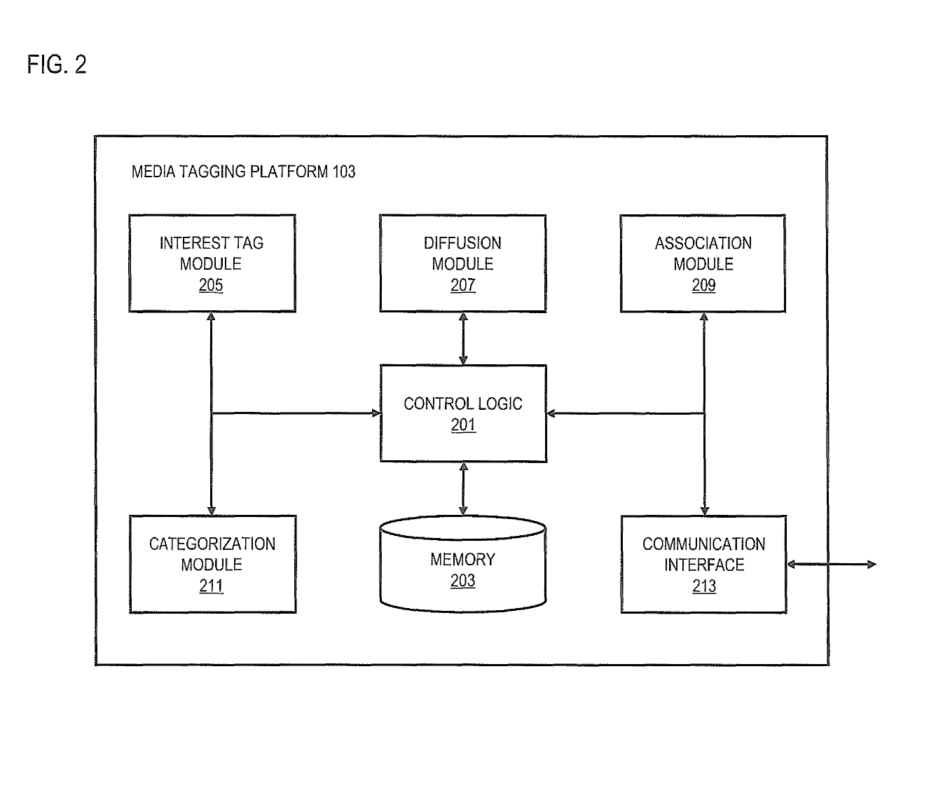

FIG. 2 is a diagram of the components of a media tagging platform, according to one embodiment. By way of example, the media tagging platform 103 includes one or more components for associating interest tags with media items based on social diffusions among users. It is contemplated that the functions of these components may be combined in one or more components or performed by other components of equivalent functionality. In this embodiment, the media tagging platform 103 includes control logic 201, memory 203, an interest tag module 205, a diffusion module 207, an association module 209, a categorization module 211, and a communication interface 213.

The control logic 201 executes at least one algorithm for executing functions of the media tagging platform 103. For example, the control logic 201 may interact with the interest tag module 205 to process user profiles to determine interest tags relating to one or more users. As indicated, the user profiles may include user preferences, relationships among the users, sharing histories, etc., and the interest tags may be determined based on a predetermined set of common categories, clarified tags, etc. In one scenario, for instance, the interest tag module 205 may determine to match at least one of the interest tags from the predetermined set to a user based on the user preferences, user relationships, and sharing histories relating to that user. As noted, since the interest tags are determined from the predetermined set, ambiguous and redundant tags may be avoided.

The control logic 201 may also work with the diffusion module 207 to determine social diffusion of the media items among the users. By way of example, social diffusion of the media items may be determined to have occurred among the users if sharing of a media item by one user to another user has occurred. Upon such determination, the association module 209 may cause an association of the media items with the interest tags based on the social diffusion. As discussed, because the social diffusion approach to media tagging does not need to rely on textual descriptions and tagging information embedded in the media items, the issue of insufficient embedded textual descriptions and tagging information in personal media content (or other media items) may be overcome.

In certain embodiments, the association module 209 may cause an addition and/or a modification to a potential tag set associated with a media item based on the sharing of the media item by one user to another user, and the association of the media items with the interest tags may further be based on the addition and/or the modification to the potential tag set. In other embodiments, the association module 209 may cause a tagging of the media item with at least one of the interest tags associated with the one user and/or the other user based on the sharing of the media item and one or more predetermined criteria. As discussed, these predetermined criteria may, for instance, include a relationship criterion, a time criterion, and/or a frequency criterion.

In some embodiments, the association module 209 may also work with the categorization module 211 to cause a categorization of the users into one or more communities based on the interest tags, the user profiles, etc. In further embodiments, the association module 209 may then determine seed users from the communities based on a determination to cover the interest tags associated with the communities. As indicated, to initiate social diffusion of media items among users, the association module 209 may then cause a generation of one or more recommendations of the media items for the seed users.

The control logic 201 may additionally utilize the communication interface 213 to communicate with other components of the media tagging platform 103, the UEs 101, the service platform 113, the services 115, the content providers 117, and other components of the system 100. For example, the communication interface 213 may be utilized to receive data corresponding to the user profiles from the UEs 101 and/or the services 115 and to redirect the data to the interest tag module 205 for processing. The communication interface 213 may further include multiple means of communication. In one use case, the communication interface 213 may be able to communicate over short message service (SMS), multimedia messaging service (MMS), interne protocol, email, instant messaging, voice sessions (e.g., via a phone network), or other types of communication.

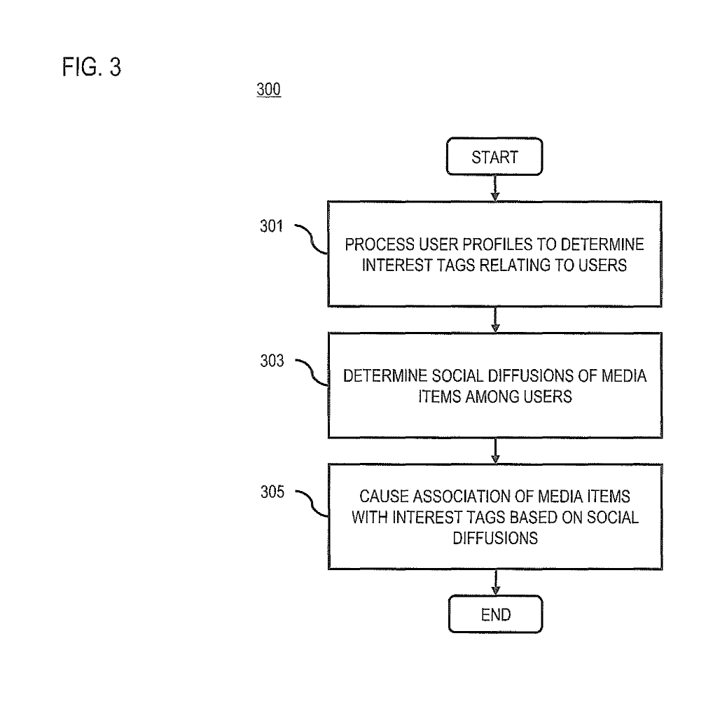

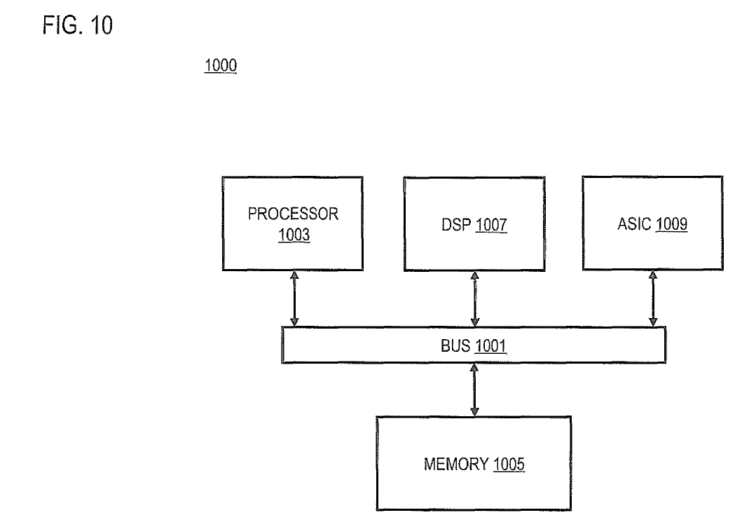

FIG. 3 is a flowchart of a process for associating interest tags with media items based on social diffusions among users, according to one embodiment. In one embodiment, the media tagging platform 103 performs the process 300 and is implemented in, for instance, a chip set including a processor and a memory as shown in FIG. 10. As such, the control logic 201 can provide means for accomplishing various parts of the process 300 as well as means for accomplishing other processes in conjunction with other components of the media tagging platform 103.

In step 301, the control logic 201 may process and/or facilitate a processing of one or more user profiles to determine one or more interest tags relating to one or more users. As indicated, in certain embodiments, the one or more user profiles may include one or more user preferences, one or more relationships among the one or more users, one or more sharing histories, or a combination thereof. As such, in one use case, users' past share behaviors may be taken into consideration by processing view/share logs specified in user profiles. Additionally, in some embodiments, the one or more interest tags may be determined based on a predetermined set of common categories and/or clarified tags. For example, the tags of the predetermined set may be specifically chosen and predefined (e.g., by administrators, developers, etc.) to ensure clarity. Thus, since the interest tags are determined from the predetermined set, ambiguous and redundant interest tags may be avoided.

In step 303, the control logic 201 may determine one or more social diffusions of the one or more media items among the one or more users. Then, in step 305, the control logic 201 may cause an association of the one or more media items with the one or more interest tags based on the one or more social diffusions. In one scenario, for instance, the social diffusions may include a sharing of at least one of the media items by at least one of the users to at least another one of the users. As mentioned, since common interests tags (or common interests) between pairwise sharers may reflect the character of a shared media item, those common interest tags may be relevant tags for the shared media item. For example, certain common interest tags may represent attributes of a shared media item with a higher probability where those common interest tags reappear frequently among pairwise sharers for the shared media item. As such, the association of the media items with the interest tags may be based on the sharing. In this way, the issue of insufficient embedded textual descriptions and tagging information in personal media content (or other media items) may be overcome since media tagging may be accomplished without having to rely exclusively on such textual descriptions and tagging information embedded in the media items.

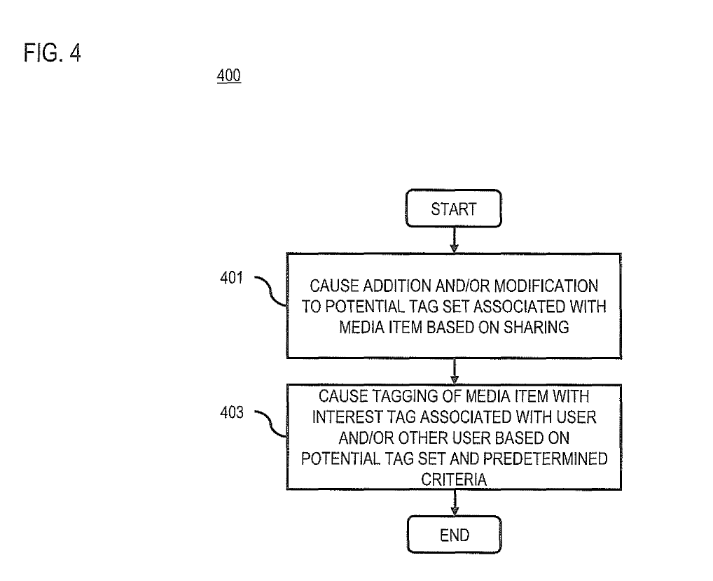

FIG. 4 is a flowchart of a process for tagging media items based on a potential tag set, according to one embodiment. In one embodiment, the media tagging platform 103 performs the process 400 and is implemented in, for instance, a chip set including a processor and a memory as shown in FIG. 10. As such, the control logic 201 can provide means for accomplishing various parts of the process 400 as well as means for accomplishing other processes in conjunction with other components of the media tagging platform 103.

In step 401, the control logic 201 may cause an addition, a modification, or a combination thereof to a potential tag set associated with the at least one media item based on the sharing (of at least one of the media items by at least one of the one or more users to at least another one of the one or more users). By way of example, the sharing of the media item may cause a common interest tag of the sharing user (e.g., the at least one user) and the receiving user (e.g., the at least another user) to be added to the potential tag set as potential tags for the media item and/or cause a modification of the tags in the potential tag set based on the common interest tag of the two users. Tags of the potential tag set may, for instance, be assigned a particular weight subject to future modifications (e.g., based on future sharing of the media item).

In step 403, the control logic 201 may cause a tagging of the at least one media item with at least one of the one or more interest tags associated with the at least one user, the at least another user, or a combination thereof based on the potential tag set and one or more predetermined criteria. As discussed, in some embodiments, the one or more predetermined criteria may include a relationship criterion, a time criterion, a frequency criterion, or a combination thereof. In one scenario, for instance, these potential tags may, for instance, be assigned a specific weight based on the relationship between the users (e.g., sharing histories between the two users, mutuality of shares, etc.), the number of times the media item has been shared, the frequency that the potential tags appear as common interest tags of users in sharing transactions, etc. Thus, the predetermined criteria may be utilized to determine the “degree of reliability” of those derived potential tags. As social diffusion continues, more information may be collected and higher precision may be achieved. However, if a predefined threshold is reached (e.g., when the tags of the potential tag set converges (and fluctuation is below the threshold)) based on the predetermined criteria, those tags may then be associated with the media item (e.g., by indicating those tags in metadata of the media item).

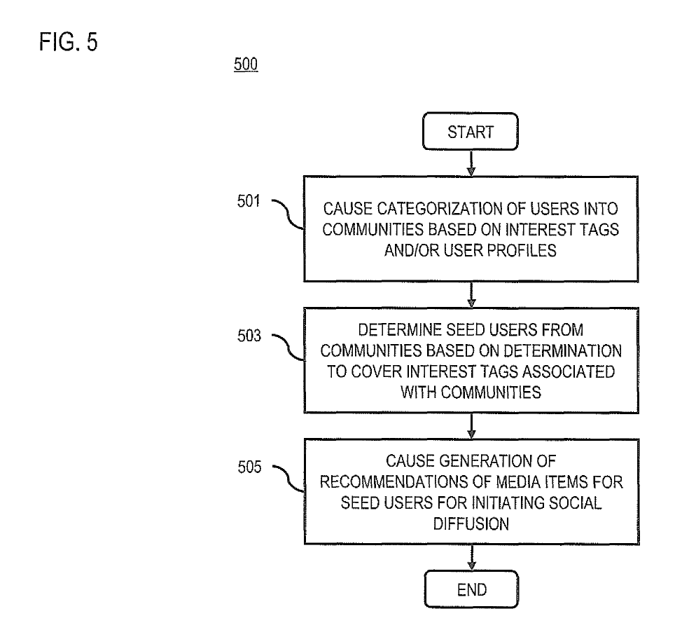

FIG. 5 is a flowchart of a process for initiating social diffusion of media items among users, according to one embodiment. In one embodiment, the media tagging platform 103 performs the process 500 and is implemented in, for instance, a chip set including a processor and a memory as shown in FIG. 10. As such, the control logic 201 can provide means for accomplishing various parts of the process 500 as well as means for accomplishing other processes in conjunction with other components of the media tagging platform 103.

In step 501, the control logic 201 may cause a categorization of the one or more users into one or more communities based on the one or more interest tags, the one or more user profiles, or a combination thereof. For example, users may be divided into different social latent communities based on their corresponding interest tags, their user relationships, and their sharing histories (e.g., derived from their user profiles). In one use case, certain users may be placed together in the same “hip-hop” social community if, for instance, those users are friends, they have previously shared media items amongst each other, and they are interested in hip-hop music.

Then, in step 503, the control logic 201 may determine one or more seed users from the one or more communities based on a determination to cover the one or more interest tags associated with the one or more communities. As mentioned, in various embodiments, social diffusion may be focused around uploaders of media items. However, because uploaders may sometimes only make up a small group, some potential tags may not be covered by the interest tags relating to that group. Thus, in certain embodiments, users having different interest tags may be selected as seed users to cover all, or most, of the possible potential tags (e.g., from the predetermined set of common categories, clarified tags, etc.). For example, users may be randomly selected from each of the social latent communities to be seed users to form a selected seed group having all of the interest tags associated with the social latent communities.

In step 505, the control logic 201 may cause a generation of one or more recommendations of the one or more media items for the one or more seed users, for instance, to initiate the one or more social diffusions of the one or more media items among the one or more users. Thus, in such a scenario, the one or more social diffusions may be based on the one or more recommendations. By way of example, the new or untagged media items may be recommended to seed users (e.g., which may include the uploaders of the untagged media items) to initiate sharing by the seed users to other users in their respective communities. If, for instance, a seed user views and shares a recommended media item, such actions may indicate his/her interest in the media item and, thus, interest tags relating to that seed user (e.g., common interest tags of pairwise sharers) may be assigned as potential tags with particular weights for the media item. Further views and shares by users receiving the media item may then cause modification of the potential tags' assigned weights, addition of other potential tags, etc., for example, until a reliability threshold has been satisfied, resulting in the potential tags becoming actual tags for the media item.

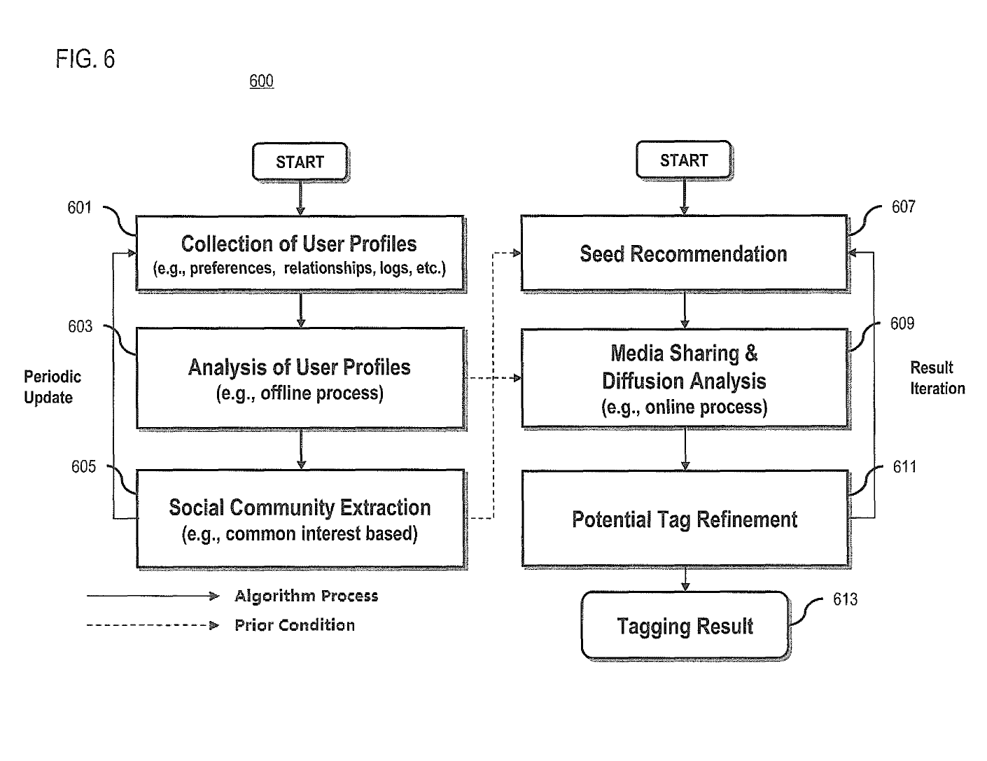

FIG. 6 is a flowchart of a process for media tagging based on social diffusions among users, according to one embodiment. In one embodiment, the media tagging platform 103 performs the process 600 and is implemented in, for instance, a chip set including a processor and a memory as shown in FIG. 10. As such, the control logic 201 can provide means for accomplishing various parts of the process 600 as well as means for accomplishing other processes in conjunction with other components of the media tagging platform 103.

In step 601, the control logic 201 may initiate collection of user profiles (e.g., that may specify user preferences, relationships, view/sharing/transfer logs, etc.), for instance, from one or more users, one or more services, etc. In step 603, user profile analysis is then performed to extract user preferences, relationships, and past sharing behavior to provide “prior knowledge” for later social diffusion analysis. For example, the user preferences, relationships, and past sharing behavior may, for instance, be analyzed to label users of a social network (e.g., the users associated with the user profiles) with interest tags, and to determine pairwise common interest tags among the users. As indicated, these pairwise common interest tags may be assigned as potential tags with weights. In certain embodiments, the weight of the potential tags may be based on the weights that are associated with the pairwise common interest tags during user profile analysis. As mentioned, a number of factors may be considered in calculating the degree of reliability (or weight) of a potential tag, including user profile similarities (e.g., many common interests, same communities, etc.), bidirectionality of relationships (e.g., bidirectional friends relationships, mutual interactions/transfers, etc.), and transfer frequencies and gaps between transfers (e.g., based on transfer logs), along with external factors, such as fashion trends, breaking news, etc. Likewise, such factors may also be utilized to calculate the degree of reliability (or weight) of the pairwise common interest tags. As illustrated, in some embodiments, such reliability/weight calculations may be performed offline upon collection of the user profiles (e.g., prior to media sharing and diffusion analysis), and the results of those calculations may then be stored as a matrix for later use, for instance, to make checking and utilization online more efficient and convenient (e.g., during the diffusion analysis).

Additionally, in step 605, the control logic 201 may initiate social community extraction, for instance, based on the common interest (e.g., pairwise common interest tags) of the users, the user profiles, etc. Social community extraction may, for instance, divide users into different social communities based on user preferences, relationships among users, and view/sharing/transfer logs (e.g., derived from the user profiles). Then, in step 607, seed users may be selected to cover all, or most, of the possible potential tags (e.g., from the predetermined set of common categories, clarified tags, etc.). For example, users may be randomly selected from each of the social communities to be seed users to form a selected seed group having all of the interest tags associated with the social communities. Subsequently, new or untagged media items may be recommended to the seed users to initiate social diffusion of those media items.

As the seed users view and share the recommended media items, the control logic 201 may initiate analysis of the media sharing and diffusion (step 609). By way of example, all sharing behavior during social diffusion will be tracked and analyzed. Each time sharing occurs, for instance, the transaction may be recorded with respect to the sender and the receiver of the media item. Although media sharing and diffusion analysis may be performed offline by processing media transfer logs obtained via a number of collection techniques, the analysis may also be performed in real-time as social diffusion occurs. In one use case, for instance, as one user shares a media item with another user, a potential tag and its associated weight may be derived from their common interest tags and their relationships (e.g., friend, parent, co-worker, frequent sharers, etc.). However, as mentioned, the motivation of sharing may vary. Thus, pre-calculated “degree of reliability” (e.g., of common interest tags) may be checked. Moreover, in some scenarios, transfers by pairwise sharer with no common interests may be ignored.

As depicted, in step 611, distribution of potential tags and their associated weights may continue to be refined, for example, as new potential tags with new scores are derived. Thus, in various embodiments, a threshold may be utilized to determine whether the result has converged, and steps 607-611 may be repeated in iteration until this requirement is satisfied. For instance, if the fluctuation is below than 5%, which is pre-defined as threshold, the result could be regarded as stable, and tags could be selected based on the score/weight rankings (e.g., tags with high degrees of reliability may be selected as auto-tagging result) (step 613).

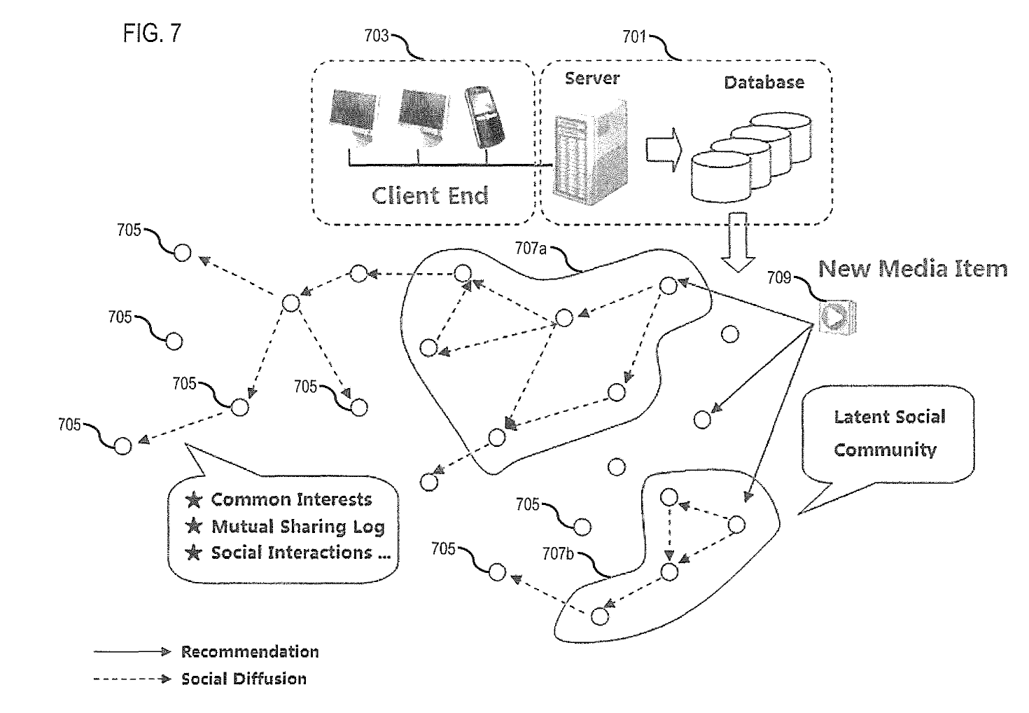

FIG. 7 is a diagram of a framework for associating interest tags with media items based on social diffusions among users, according to one embodiment. By way of example, a service 701 (e.g., hosting a media tagging platform 103) may initiate collection of user profiles from user devices associated with client end 703 (e.g., user profiles of users 705). As indicated, these user profiles may include user preferences, relationships among the users 705, sharing histories, etc., and may be processed to determine interest tags relating to the user 705 (e.g., common interest tags among the users 705). Moreover, as discussed, the users 705 may be categorized into one or more latent social communities (e.g., including social communities 707a and 707b) based on their interest tags and/or their user profiles. To initiate automated media tagging through social diffusion among the users 705, various seed users may be selected and recommended untagged media items (e.g., new media item 709). In this scenario, for instance, media item 709 is initially recommended to three seed users who then share the media item 709 to other users within and outside of their social communities. As recommended media items are shared, analysis of the media sharing and diffusion may be performed to determine media tags for the media items.

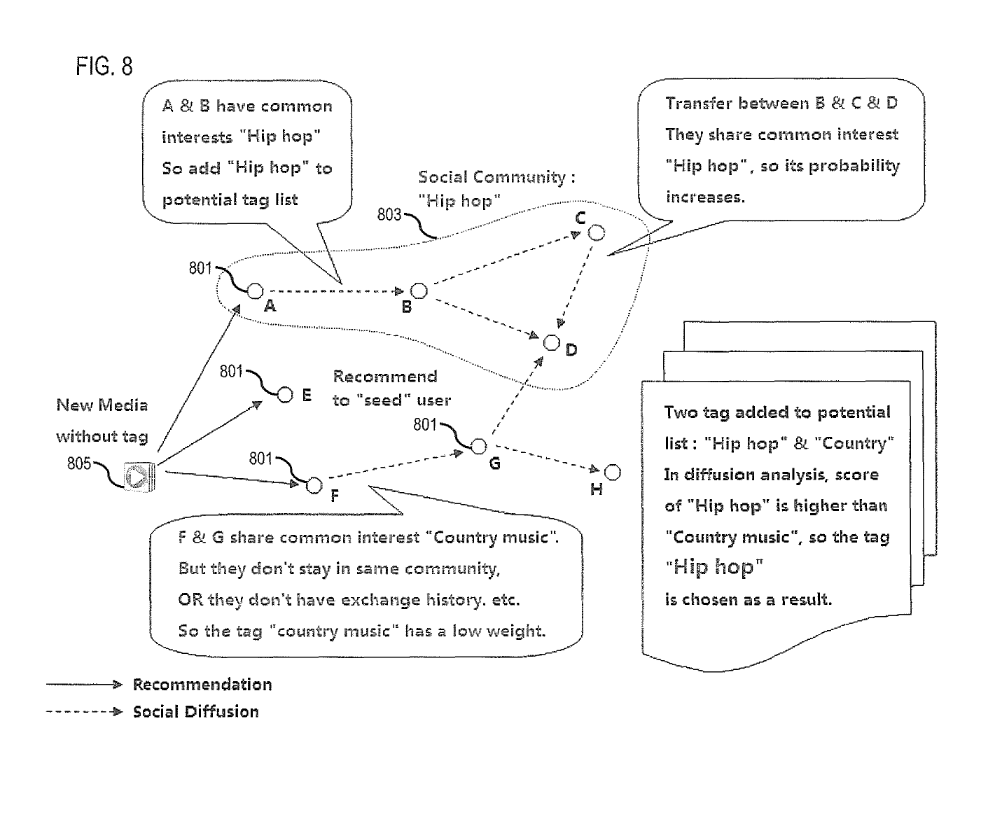

FIG. 8 is a diagram of a scenario where interest tags are associated with media items based on social diffusions among users, according to one embodiment. For example, as shown, users 801a-801d belong to social community 803 (e.g., hip-hop), while users 801e-801h belong to various other social communities. As indicated, such categorization of users into social communities may be based a user profile analysis and/or interest tags (e.g., common interest tags of pairwise sharers) derived from a user profile analysis (e.g., analysis of user preferences, relationships, sharing histories, etc.). To promote social diffusion among the users 801a-801h and to initiate tagging of media item 805 (e.g., new media item without tags), seed users 801a, 801e, and 801f are selected and recommended the media item 805.

As depicted, when user 801a shares the media item 805 to user 801b, the “hip-hop” interest tag is added to a potential tag set (or list) associated with the media item 805. In this scenario, the tag “hip-hop” may be assigned a relatively high weight since users 801a and 801b have the same common interest of “hip-hop” and since those users are in the same social community. Moreover, because the media item 805 is continuously shared throughout the social community 803 by its users who also share the common interest “hip-hop” (e.g., users 801b shared the media item 805 to users 801c and 801d, users 801c shared the media item 805 to users 801d, etc.), the assigned weight of the potential tag “hip-hop” continued to increase. As such, the probability that the potential tag “hip-hop” reflects the characteristics of the media item 805 is also increased.

Similarly, when user 801f shares the media item to user 801g, the “country music” interest tag may be added to the potential tag set (or list) associated with the media item 805 based on the common interest “country music” between the two users. However, the tag “country music” may be assigned a low weight, for example, since users 801f and 801g are not part of the same social community, they do not have a previous exchange history, etc. As such, when social diffusion analysis is performed, the score/weight of the potential tag “hip-hop” will be much greater than the score/weight of the potential tag “country music.” Thus, assuming that all other predetermined criteria have also been satisfied, “hip-hop” may be chosen as a media tag for the media item 805.

The processes described herein for associating interest tags with media items based on social diffusions among users may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

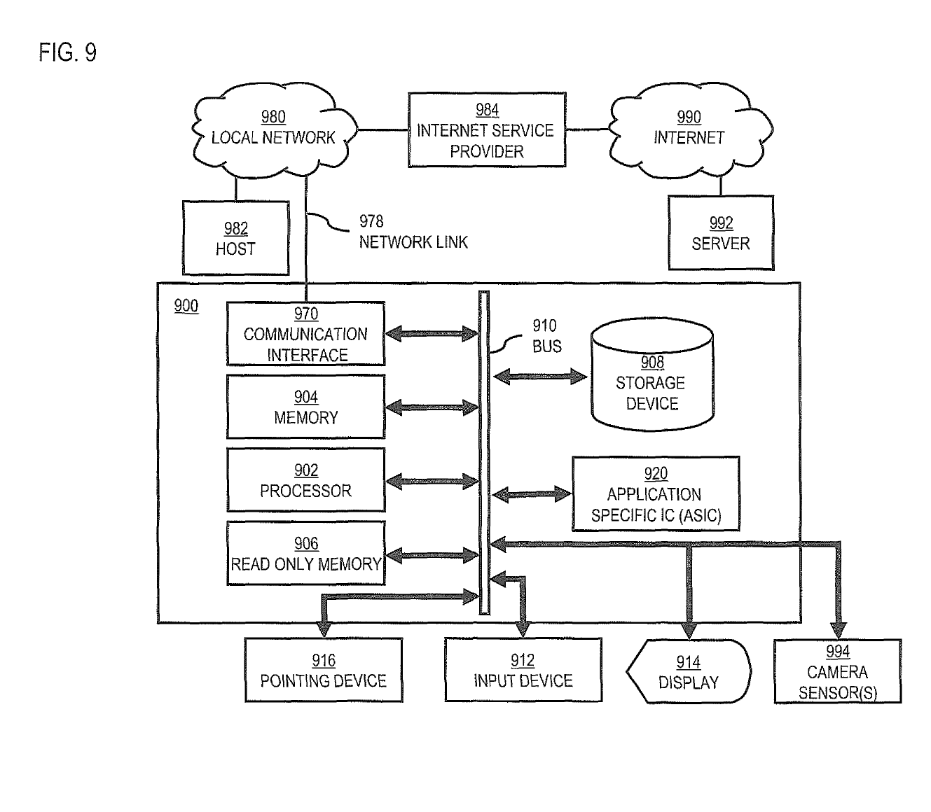

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to associate interest tags with media items based on social diffusions among users as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of associating interest tags with media items based on social diffusions among users.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to associating interest tags with media items based on social diffusions among users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for associating interest tags with media items based on social diffusions among users. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for associating interest tags with media items based on social diffusions among users, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for associating interest tags with media items based on social diffusions among users to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to associate interest tags with media items based on social diffusions among users as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of associating interest tags with media items based on social diffusions among users.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to associate interest tags with media items based on social diffusions among users. The memory 1005 also stores the data associated with or generated by the execution of the inventive steps.

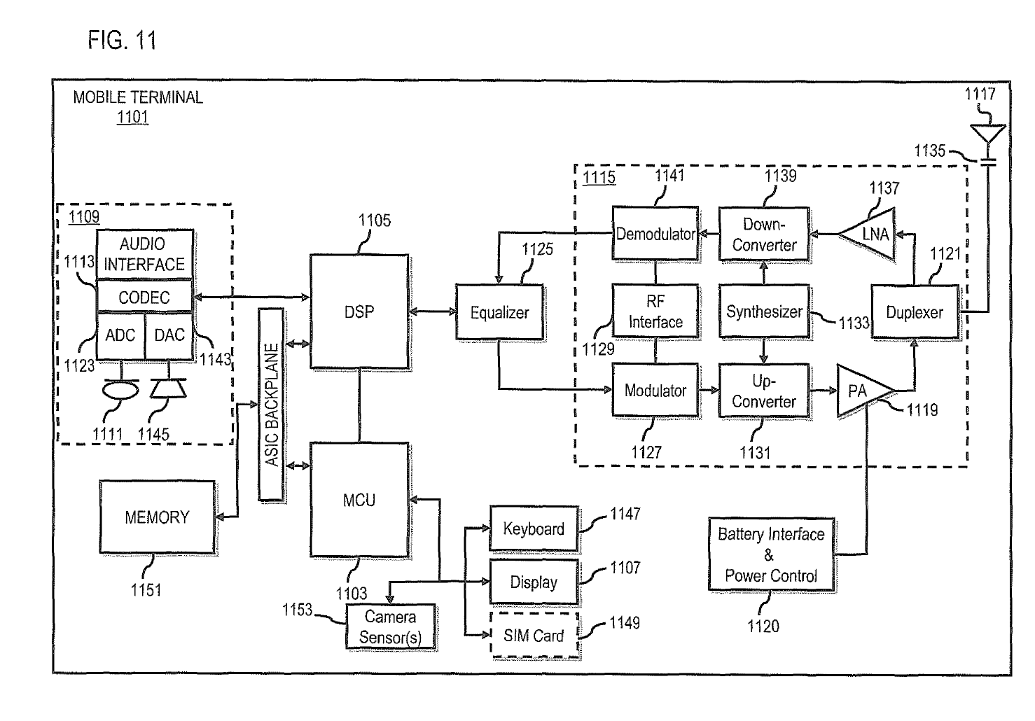

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of associating interest tags with media items based on social diffusions among users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of associating interest tags with media items based on social diffusions among users. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to associate interest tags with media items based on social diffusions among users. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more user profiles to determine one or more interest tags relating to one or more users;
determine one or more social diffusions of one or more media items among the one or more users; and
cause, at least in part, an association of the one or more media items with the one or more interest tags based, at least in part, on the one or more social diffusions.

40. An apparatus of claim 39, wherein the one or more social diffusions includes, at least in part, a sharing of at least one of the one or more media items by at least one of the one or more users to at least another one of the one or more users.

41. An apparatus of claim 40, wherein the apparatus is further caused to:
cause, at least in part, an addition, a modification, or a combination thereof to a potential tag set associated with the at least one media item based, at least in part, on the sharing,
wherein the association is further based, at least in part, on the addition, the modification, or a combination thereof.

42. An apparatus of claim 40, wherein the apparatus is further caused to:
cause, at least in part, a tagging of the at least one media item with at least one of the one or more interest tags associated with the at least one user, the at least another user, or a combination thereof based, at least in part, on the sharing and one or more predetermined criteria.

43. An apparatus of claim 42, wherein the one or more predetermined criteria include, at least in part, a relationship criterion, a time criterion, a frequency criterion, or a combination thereof.

44. An apparatus of claim 39, wherein the apparatus is further caused to:
cause, at least in part, a categorization of the one or more users into one or more communities based, at least in part, on the one or more interest tags, the one or more user profiles, or a combination thereof.

45. An apparatus of claim 44, wherein the apparatus is further caused to:
determine one or more seed users from the one or more communities based on a determination to cover the one or more interest tags associated with the one or more communities,
wherein the one or more seed users include, at least in part, the at least one user, at least one provider of the at least one media item, or a combination thereof.

46. An apparatus of claim 45, wherein the apparatus is further caused to:
cause, at least in part, a generation of one or more recommendations of the one or more media items for the one or more seed users,
wherein the one or more social diffusions are based, at least in part, on the one or more recommendations.

47. An apparatus of claim 39, wherein the one or more interest tags are determined based, at least in part, on a predetermined set of one or more common categories, one or more clarified tags, or a combination thereof.

48. An apparatus of claim 39, wherein the one or more user profiles include, at least in part, one or more user preferences, one or more relationships among the one or more users, one or more sharing histories, or a combination thereof.

49. A method comprising:
processing and/or facilitating a processing of one or more user profiles to determine one or more interest tags relating to one or more users;
determining one or more social diffusions of one or more media items among the one or more users; and
causing, at least in part, an association of the one or more media items with the one or more interest tags based, at least in part, on the one or more social diffusions.

50. A method of claim 49, wherein the one or more social diffusions includes, at least in part, a sharing of at least one of the one or more media items by at least one of the one or more users to at least another one of the one or more users.

51. A method of claim 50, further comprising:
causing, at least in part, an addition, a modification, or a combination thereof to a potential tag set associated with the at least one media item based, at least in part, on the sharing,
wherein the association is further based, at least in part, on the addition, the modification, or a combination thereof.

52. A method of claim 50, further comprising:
causing, at least in part, a tagging of the at least one media item with at least one of the one or more interest tags associated with the at least one user, the at least another user, or a combination thereof based, at least in part, on the sharing and one or more predetermined criteria.

53. A method of claim 52, wherein the one or more predetermined criteria include, at least in part, a relationship criterion, a time criterion, a frequency criterion, or a combination thereof.

54. A method of claim 49, further comprising:
causing, at least in part, a categorization of the one or more users into one or more communities based, at least in part, on the one or more interest tags, the one or more user profiles, or a combination thereof.

55. A method of claim 54, further comprising:
determining one or more seed users from the one or more communities based on a determination to cover the one or more interest tags associated with the one or more communities,
wherein the one or more seed users include, at least in part, the at least one user, at least one provider of the at least one media item, or a combination thereof.

56. A method of claim 55, further comprising:
causing, at least in part, a generation of one or more recommendations of the one or more media items for the one or more seed users,
wherein the one or more social diffusions are based, at least in part, on the one or more recommendations.

57. A method of claim 49, wherein the one or more interest tags are determined based, at least in part, on a predetermined set of one or more common categories, one or more clarified tags, or a combination thereof.

58. A non-transitory computer-readable storage medium carrying one or more sequences of one or more instructions which, when executed by one or more processors, cause an apparatus to perform at least:
processing and/or facilitating a processing of one or more user profiles to determine one or more interest tags relating to one or more users;
determining one or more social diffusions of one or more media items among the one or more users; and
causing, at least in part, an association of the one or more media items with the one or more interest tags based, at least in part, on the one or more social diffusions.
